(19) United States
(12) Patent Application Publication
(10) Pub. No.: US 2005/0183738 A1
(43) Pub. Date: Aug. 25, 2005

(54) Device for maintaining the hygiene of the teeth, oral cavity and hands while traveling

(76) Inventors: Marie Jankovcova, Prague (CZ); Karel Benda, Prague (CZ)

Correspondence Address: Edward J. Benda, 512 Palo Alto Drive, Vancouver, WA, 98661, US

(21) Appl. No.: 11/057,436

(22) Filed: Feb. 15, 2005

Related U.S. Application Data
(60) Provisional application No. 60/546,447, filed on Feb. 20, 2004.

(51) Int. Cl. A61C 15/00

(52) U.S. Cl. 132/321

(57) ABSTRACT

This device for the hygiene of the teeth, oral cavity and hands while traveling solves the problems of hygiene of the teeth, between the teeth, the oral cavity and hands outside the home and on travel everywhere no water, soap or clean towels are available. It features and contains a combined package of dental floss with cleaning tissues in a single, small, light, soft, flexible pack not interfering with the body or clothes, which can be handy, without problems, almost always, at any opportunity. It shall enable cleaning between the teeth after a meal anywhere and cleaning the hands well before and after use, thus providing a feeling of cleanliness and self-confidence, especially in contact with others.

### BRIEF SUMMARY OF THE INVENTION

The invention pertains to the hygiene of the teeth, oral cavity and hands while traveling. When away from home, while traveling or hiking, in a car or on trips, or during get-togethers outdoors where no water, soap, or clean towels are available, the problem frequently arises as to how to clean the hands and teeth after meals in a hygienic manner. Perhaps we all want to have a feeling of cleanliness and selfconfidence after meals, often while we are out. Our invention provides a contribution to solving this problem.

### BACKGROUND OF THE INVENTION

It is generally known that brushing the teeth after meals is of major importance to maintain healthy teeth, fresh odor free breath, and healthy gums. In most cases, bad breath, caries, and periodontitis are based on an insufficient cleaning of these areas. If we have food caught between the teeth, we do not feel comfortable and have a feeling of insecurity. We are shy of speaking freely and smiling warmly. We do not make a good impression on our companions. This feeling increases if we have dirty hands.

### CURRENT STATE OF DENTAL HYGIENE AIDS

A toothbrush and toothpaste, combined with dental floss, are an excellent means for cleaning the teeth after meals, whether at home or in a hotel; however, they are not suitable while traveling and when outside the home. In other words, they are not suitable in places where water, soap, or clean towels are not available, i.e., on trips, in a car, while hiking, doing sports, or get-togethers outdoors. In addition, we cannot always have a toothbrush and toothpaste with us due to their size.

Toothpicks of any quality fail to clean the teeth perfectly in the interdental areas; they can easily break and injure the gums. In addition, they are incapable of cleaning the areas where the teeth are close together, resulting in a risk of the formation of dental caries. They also fail to provide a solution for the hygiene of hands before and after cleaning the teeth.

Dental floss removes any food remnants from the interdental spaces but current packages are most suitable for use in a bathroom at home or in a hotel. When traveling and outside the home, floss has the following disadvantages: it is packaged in hard containers which are not sealed tightly. The floss is usually long, intended for multiple use. Dust and dirt penetrate the boxes when carried in the pockets of clothes or in purses or bags. Accordingly, even relatively new floss can become harmful, in hygienic terms, in such cases. A purse or bag is often unavailable and boxes of dental floss carried in the pockets of clothes often get in the way and are visible under the clothes. For these reasons, some people dislike carrying these hard boxes with them. They interfere directly during sports and while hiking. Dental floss, in a box used while traveling and outside the home, fails to solve important problems, such as the hygiene of the hands before and after the use. Working in the mouth with dirty hands and dental floss contravenes all known hygienic principles. And remaining with unclean hands afterwards is perhaps even a much worse hygienic failure. With unclean hands, we can contaminate and, possibly, infect others.

Various small brushes for cleaning between the teeth are unsuitable for travel due to their dimensions; they have hard contours and corners, are not intended for single use, being expensive and lacking measures for hand hygiene before and after use. The brushes cannot be cleaned in locations where water is unavailable.

Various dental floss holders try to eliminate the hygiene problems and failures. However, the solution is incomplete, as the hands come into contact with the oral cavity in this case as well, and the package fails to meet the requirements for traveling, tourism, and sports. Even the size and the sharpness of the edges and corners are uncomfortable and can be dangerous when carried on the body. The floss fixed in the holder features another drawback in that it has no free end, as does manually handled dental floss, and accordingly, it cannot be pulled through the wider spaces between the teeth, i.e., exactly where food particles are usually trapped, while the tight floss can easily damage the teeth and/or fillings when being pulled out. Handling the dental floss directly with the hands without holders, when cleaning between the teeth, is much more effective and sensitive.

All of the aforementioned and currently known means for dental hygiene fail to fully meet the requirements for dental hygiene while traveling or outside the home, where no water, soap or clean towels are available. The main shortcomings of all the aforementioned products for the removal of food from between the teeth while traveling, during trips, in cars, during sports, tourism, get-togethers outdoors and outside the home in general, are as follows:

They fail to solve the issue of hand hygiene before and after cleaning between the teeth and provide no possibility for it. Due to their size, packaging and bulkiness, they cannot be carried continuously without problems. This means that their use is very limited.

### DISCLOSURE OF THE INVENTION

The purpose of our invention is to provide a simple and practical solution to the aforementioned shortcomings of the currently known devices for dental hygiene while traveling and outside the home. The principle of the invention is a device for the hygiene of the teeth, oral cavity and hands while traveling, represented by a combined packaging of dental floss in a single package along with one or several cleaning tissues/wipes of sufficient size. This practical packaging will provide us with the opportunity to perfectly clean and partially disinfect the hands both before the use of the dental floss and after cleaning the teeth. The package must be small and slim, if possible, preferably rectangular, approximately 6-12 cm long, 4 to 8 cm wide and several millimeters up to 15 mm thick. In addition, the package must be well sealed, impermeable, light, soft, flexible to fit the contours of the body and not creating a substantial hindrance under any circumstances when carried close to the body. A small package for single use can be sold on the market either individually or in a larger package with several items. This new, combined package will enable us to have this new product with us, virtually all the time, under any situation while traveling and outside the home. The cleaning tissues can be dry or wet. Wet cleaning tissues are certainly preferable. They can contain various additives, such as for disinfection, cleaning and the treatment of hands. Fragrance additives are also possible. Always in accordance with the current state of technology. This combination, i.e., a collective package of dental floss along with cleaning tissues/wipes, is complementary in terms of function. It ensures both the hygienic cleaning of the teeth using the dental floss, hygienic cleaning of the hands prior to cleaning the teeth, and it assures hygienic cleaning of the hands after cleaning the teeth. Hence, it increases substantially both personal hygiene and hygienic contact with others. The result of this combination is useful for society and is qualitatively higher than currently known products. This mutual and practical combination of these two hygienic methods will allow the multiple use thereof. It shall allow hygiene of teeth, oral cavity and hands under any conditions on the road and outside the home, and shall improve overall personal hygiene and the overall state of health.

Our invention meets the following objectives:

It will enable cleaning of food particles from between the teeth and the hygienic cleaning and partial disinfection of the hands both prior to and after the cleaning of teeth, everywhere water, soap, and clean towels are not available. This personal cleanliness provides us with a feeling of self-assurance and self-confidence when dealing and in contact with other people and while socializing. It provides a substantial contribution to maintaining healthy teeth and fresh breath. It serves as prevention against caries and periodontitis. It Will substantially prevent the infection of the oral cavity due to dirty hands. By cleaning our hands with a cleaning tissue after cleaning the teeth, we prevent the transmission of various infections, as the case may be, to others. In this way, we will improve both our general state of health, and the state of health of others. Due to its small, light, soft, slim, flexible, well-sealed, waterproof package, the product can be carried virtually all the time, on any occasion, in any garment. The product does not pinch, does not increase the volume of the pocket substantially or become visible under the clothes. It adjusts to the body's contours. As it contains both the cleaning tissues and the dental floss, both the components of dental and hand hygiene are always together. No situation may occur where either the dental floss or the cleaning tissues are missing. Both the dental floss and the cleaning tissues remain clean and unsoiled even after longer carrying in the pocket, purse, or bag, unlike dental floss packed in a box. It is intended for single use, so we don't need to clean everything. Thus, our invention has solved a long-perceived need as to how to clean food particles from the teeth hygienically and complete this procedure with the immediate option to clean the hands hygienically, while traveling or outside the home, where no water, soap, or clean towels are available. No other product or invention has met these requirements so far. The invention presented by us improves and combines the currently known benefits of dental floss with the benefits of cleaning tissues. Our invention contains a combination of the two elements, which are related to each other, and their combination acts to achieve a uniform total effect.

### EXAMPLE

An example of the design of the invention is the product as a package with approximate dimensions of 7×8×0.3 cm. Two wet cleaning tissues are contained inside the package (one is intended to clean the hands before use, and one after the use of the dental floss) and dental floss approximately 50 cm long. The tissues have dimensions of approximately 30×19 cm, and are soaked in hygienic ingredients. The cover of the package is made of waterproof, easily opening foil, which is soft, light, and flexible. The product is intended for a single use only. These small packages are suitable for single distribution. They can be distributed in automatic slot machines located in railway stations, in gasoline stations, in supermarkets or pharmacies, and so on. Small packages may also be grouped together for distribution and sold in five or more units in larger packs.

### INDUSTRIAL APPLICABILITY

The product is applicable in industry and is intended for the consumption of the general public.

1. A device for the hygiene of the teeth, oral cavity and hands while traveling, characterized by the combined packaging of one or more pieces of dental floss with one or more cleaning towels in a single small package, wherein both the dental floss and the cleaning tissues can be dry or wet, produced from different materials, and improved with various additives.
